(19) United States
(12) Patent Application Publication
(10) Pub. No.: US 2024/0177575 A1
(43) Pub. Date: May 30, 2024

(54) SYSTEM AND METHOD FOR PROVIDING AN AUTOMATED PULL REQUEST USING CROSS-CHANNEL COMMUNICATION

(71) Applicant: BANK OF AMERICA CORPORATION, Charlotte, NC (US)

(72) Inventors: Eric Dryer, Charlotte, NC (US); Gary L. Best, JR., Acworth, GA (US); Daryl Kip Ujita, Alhambra, CA (US)

(73) Assignee: BANK OF AMERICA CORPORATION, Charlotte, NC (US)

(21) Appl. No.: 17/994,798

(22) Filed: Nov. 28, 2022

(51) Int. Cl. G07F 19/00; G06Q 10/20

(52) U.S. Cl. CPC G07F 19/209; G06Q 10/20

(57) ABSTRACT

Systems, computer program products, and methods are described herein for providing an automated pull request using cross channel communications. The method includes receiving an executed action request including a request to obtain information relating to an executed action on an executed action date. The information is obtained via servicing an automated teller machine associated with the executed action. The method also includes determining a last service date for the automated teller machine associated with the executed action. The method further includes comparing the last service date for the automated teller machine associated with the executed action to the executed action date. The method further includes causing a service action related to the automatic teller machine to be executed based on the determination of the last service date before the executed action date.

### TECHNOLOGICAL FIELD

Example embodiments of the present disclosure relate to a system and method for providing an automated pull request using cross-channel communication.

### BACKGROUND

The use of automatic teller machines can result in processing errors from a wide range of sources. Many of these processing errors are difficult or impossible to resolve unless there is an inspection of the machine and its contents. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for providing an automated pull request using cross-channel communication.

In an example embodiment, a system for providing an automated pull request using cross-channel communication is provided. The system includes at least one non-transitory storage device and at least one processing device coupled to the at least one non-transitory storage device. The at least one processing device is configured to receive an executed action request. The executed action request includes a request to obtain information relating to an executed action performed on an executed action date. The information relating to the executed action is obtained via servicing an automated teller machine associated with the executed action. The at least one processing device is also configured to determine a last service date for the automated teller machine associated with the executed action. The at least one processing device is further configured to compare the last service date for the automated teller machine associated with the executed action to the executed action date. The at least one processing device is still further configured to cause a service action related to the automated teller machine to be executed based on determining whether the last service date is before the executed action date.

In various embodiments, the at least one processing device is also configured to determine a next service date of the automated teller machine. In such an embodiment, the service action includes a transmission of a request for expedited servicing in an instance in which the next service date is greater than a predetermined number of days from an executed action request date that the executed action request was received.

In various embodiments, the service action is a transmission of a request for servicing of the automated teller machine within a predetermined number of days. In various embodiments, the service action is a transmission of a request to update a service schedule of the automated teller machine.

In various embodiments, the executed action request is based on a potential malfunction in a processing of the executed action by automated teller machine. In various embodiments, the potential malfunction in the processing of the executed action by the automated teller machine is a photographic processing error of the automated teller machine.

In various embodiments, the executed action is a category of usage of the automatic teller machine, the category of usage is one of a check deposit or a cash deposit.

In another example embodiment, a computer program product for providing an automated pull request using cross-channel communication is provided. The computer program product includes at least one non-transitory computer-readable medium having computer-readable program code portions embodied therein. The computer-readable program code portions include an executable portion configured to receive an executed action request. The executed action request includes a request to obtain information relating to the executed action performed on an executed action date. The information relating to the executed action is obtained via servicing an automated teller machine associated with the executed action. The computer-readable program code includes an executable portion configured to determine a last service date for the automated teller machine associated with the executed action. The computer-readable program code portions further include an executable portion configured to compare the last service date for the automated teller machine associated with the executed action to the executed action date. The computer-readable program code portions further include an executable portion configured to cause a service action related to the automated teller machine to be executed based on the determination of the last service date.

In various embodiments, the computer program product also includes an executable portion configured to determine a next service date of the automated teller machine and the service action includes a transmission of a request for expedited servicing in an instance in which the next service date is greater than a predetermined number of days from an executed action request date that the executed action request was received.

In various embodiments, the service action is a transmission of a request for servicing of the automated teller machine within a predetermined number of days. In various embodiments, the service action is a transmission of a request to update a service schedule of the automated teller machine.

In various embodiments, the executed action request is based on a potential malfunction in a processing of the executed action by automated teller machine. In various embodiments, the potential malfunction in the processing of the executed action by the automated teller machine is a photographic processing error of the automated teller machine.

In various embodiments, the executed action is a category of usage of the automatic teller machine and the category of usage is one of a check deposit or a cash deposit.

In still another example embodiment, a computer-implemented method for providing an automated pull request using cross-channel communication is provided. The method includes receiving an executed action request. The executed action request includes a request to obtain information relating to an executed action performed on an executed action date. The information relating to the executed action is obtained via servicing an automated teller machine associated with the executed action. The method also includes the determining a last service date for the automated teller machine associated with the executed action. The method further includes comparing the last service date for the automated teller machine associated with the executed action date. The method still further includes causing a service action related to the automated teller machine to be executed based on the determination of the last service date.

In various embodiments, the at least one processing device is configured to determine a next service date of the automated teller machine and the service action comprises a transmission of a request for expedited servicing in an instance in which the next service date is greater than a predetermined number of days from an executed action request date that the executed action request was received.

In various embodiments, the service action is a transmission of a request for servicing of the automated teller machine within a predetermined number of days. In various embodiments, the service action is a transmission of a request to update a service schedule of the automated teller machine.

In various embodiments, the executed action request is based on a potential malfunction in a processing of the executed action by automated teller machine. In various embodiments, the potential malfunction in the processing of the executed action by the automated teller machine is a photographic processing error of the automated teller machine.

In various embodiments, the executed action is a category of usage of the automatic teller machine and the category of usage is one of a check deposit or a cash deposit.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for providing an automated pull request using cross-channel communication in accordance with various embodiments of the present disclosure;

FIG. 2 illustrates a process flow for an automated pull request using cross-channel communication in accordance with various embodiments of the present disclosure; and

FIG. 3 illustrates a dispute review process flow for an automated pull request using cross-channel communication in accordance with various embodiments of the present disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority, or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of an application, or part of an application that serves as a foundation for a larger piece of software and drives the functionality of the software. In some embodiments, an engine may be self-contained, but externally controllable code that encapsulates powerful logic designed to perform or execute a specific type of function. In one aspect, an engine may be underlying source code that establishes file hierarchy, input and output methods, and how a specific part of an application interacts or communicates with other software and/or hardware. The specific components of an engine may vary based on the needs of the specific application as part of the larger piece of software. In some embodiments, an engine may be configured to retrieve resources created in other applications, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository—a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e., paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

The present disclosure provides a system for providing an automated pull request using cross channel communications. Automated teller machines (ATMs) allow for the automation of otherwise manual actions, such as cash retrieval and/or depositing, check depositing, and/or the like. As such, once human verified actions are now processed using automated actions. Said automated actions may sometimes be inaccurate due to various reasons, such as faulty sensors, illegible handwriting (e.g., poor handwriting on a check), system malfunctions, and/or the like. Therefore, entities may institute various auditing processes that allow for the physical contents of the ATM to be reviewed to ensure the correct automated action was achieved. A part of the auditing process can include reviewing actual contents of the ATM that are only achieved by physical servicing of the ATM at issue. For example, for a dispute over a check deposit, the physical check may need to be reviewed to ensure the correct action was executed and similarly, for a dispute over a cash deposit, the cash amount of the ATM may be reviewed to determine whether the cash amount matches the expected cash amount of the ATM.

Many of the disputes may be resolved through a pull request or a physical verification of the automated teller machine or the contents within. However, servicing the machines result in added expenditure of time and resources for an entity and therefore, there may be periods of time between services in which deposited checks are stored in the ATM and the cash amount can fluctuate.

Various embodiments of the system that provides for automated pull requests using cross channel communication can reduce the amount of time and resources spent on resolving issues that occur by communicating when a system recommends a pull request. As such, service periods between ATM services can be maintained or increased without negatively affecting the capabilities of the ATM (e.g., review of an ATM can be achieved without having to require more regularly scheduled services).

Accordingly, various embodiments of the present disclosure allow multiple systems involved in the functions and operations of an automatic teller machine to communicate to determine an efficient solution to an issue that is difficult to resolve unless there is direct intervention from an outside source. Multiple factors are used to determine when physical inspection of the automated teller machine and its contents may occur. The predetermined settings used to make the determination are also configurable and can be changed to obtain a solution with more benefits.

The present disclosure provides a technical solution to a technical problem. As described herein, current ATM devices and servicing protocols create a technical problem of inaccurate automated processing due to machine errors with little to no ability to review said processing. The technical solution presented herein allows for expedited processing review without creating unnecessary strain on the system. In particular, the automated communication of cross-channel systems is an improvement over existing solutions to the current pull request system: (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, and (iii) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

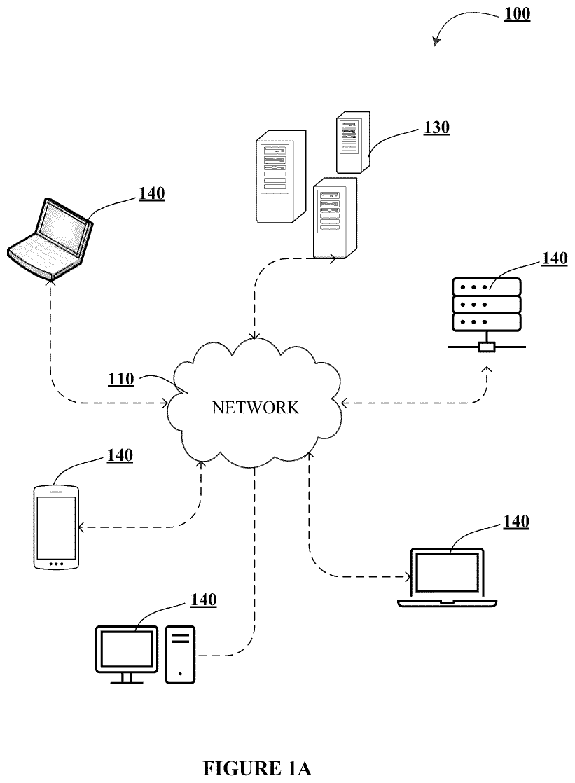

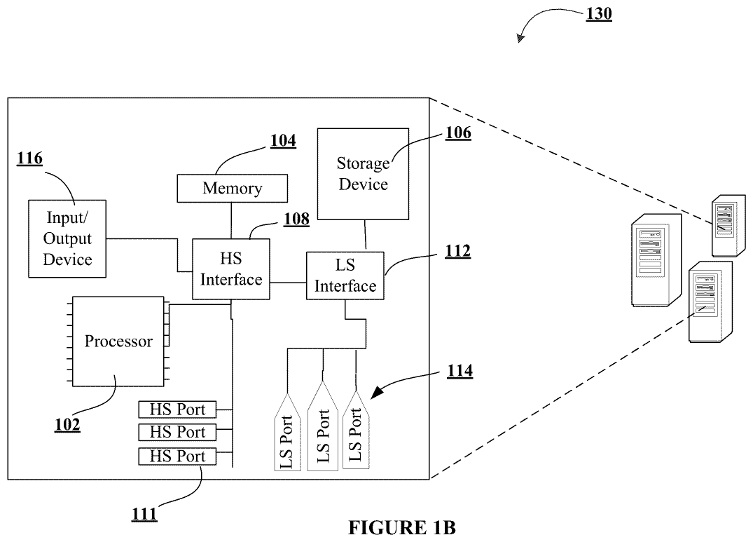

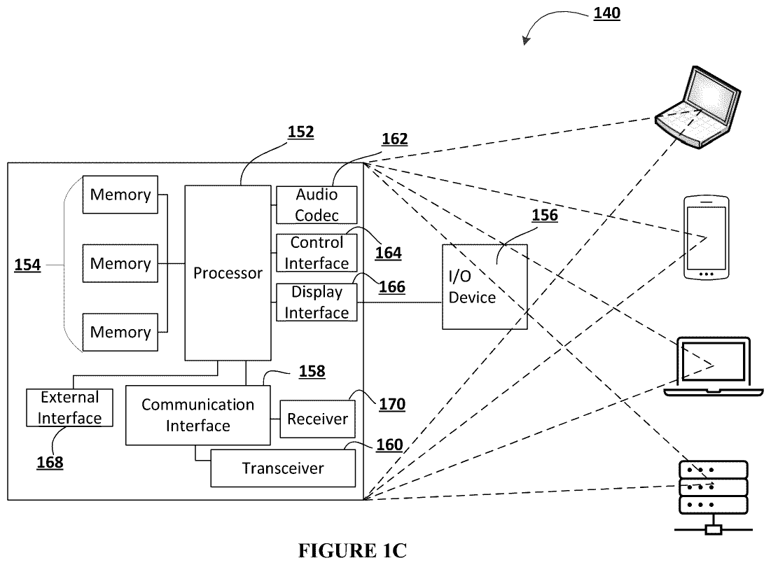

FIGS. 1A-1C illustrate technical components of an exemplary distributed computing environment for the system and method for providing an automated pull request using cross-channel communication 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 connecting to low speed expansion port 114 and storage device 106. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

The high-speed interface 108 manages bandwidth-intensive operations for the system 130, while the low speed interface 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed interface 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single in Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation—and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

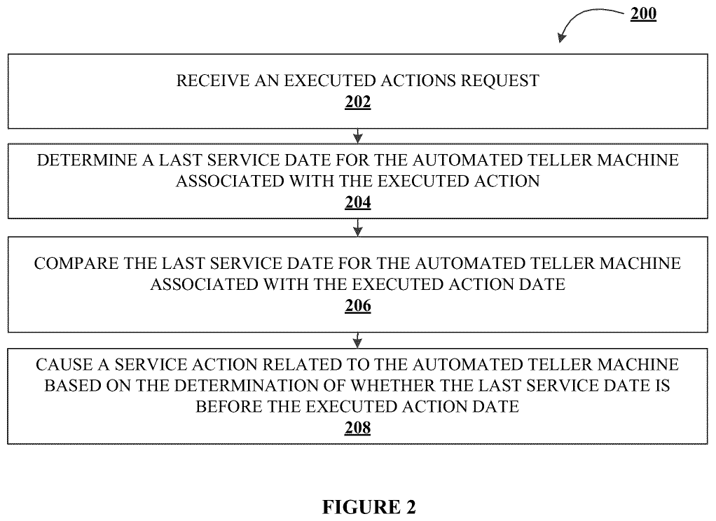

FIG. 2 is a flow chart 200 that illustrates an example of a method for providing an automated pull request using cross channel communications. The method may be carried out by various components of the distributed computing environment 100 discussed herein (e.g., the systems 130, one or more end-point devices 140, etc.). An example system may include at least one non-transitory storage device and at least one processing device coupled to the at least one non-transitory storage device. In such an embodiment, the at least one processing device is configured to carry out the method discussed herein. While the method discussed herein references an ATM, various other automated processing devices may also use the method discussed herein (e.g., an automated ticket booth may also use the method herein to review a dispute related to automated ticketing).

Referring now to Block 202 of FIG. 2, the method includes receiving an executed action request. The executed action may be associated with one or more requests to deposit or withdraw resources or deposit checks using the automatic teller machine. The executed action request comprises a request to obtain information relating to an executed action executed on an executed action date. Obtaining information relating to an execution action may include gathering information that is obtained through a physical inspection and review of the automated teller machine. The information gathered may then be used to resolve possible disputes due to an incorrect value being assigned through an interaction processed through the automatic teller machine.

In various embodiment, the executed action request may be a result of a dispute relating to the executed action. For example, a consumer may dispute an amount credited to the consumer from a deposit of cash or check at an ATM. In response to such a dispute, the entity may review available information relating to the executed action to determine whether an error occurred during process. In some instances, the review process may be resolved by reviewing digital information available. For example, the ATM may capture a picture of a check being deposited and the picture can be reviewed to determine a resolution to the dispute. However, the digital information may be incomplete or non-applicable, such that a service of the ATM is necessary. For example, a check image may be obscured due to an imaging issue, or the cash balance may need to be manually reviewed to confirm the correct cash balance. As such, the executed action request may be a request for such physical information (e.g., physical check deposited or manual cash balance count of the ATM).

Servicing of an ATM or related device may include a physical inspection of the ATM for any checks stored in the ATM and/or a count of the cash balance in the ATM. During servicing, one or more sensors or ATM components may also be tested by a technician. ATM servicing is typically completed periodically and conducted by scheduling a servicing date. During a service, an individual attends to the ATM by performing maintenance to ensure the automated teller machine is functioning properly. The servicing dates of the automated telling machine are designed to be conducted on a regular schedule. As technology has advanced, the time necessary between services of a single ATM has increased. The addition of a servicing date outside of the established schedule is often burdensome to multiple sources due to the additional logistical difficulties and resource related issues. The information relating to the executed action is obtained via servicing the automated teller machine associated with the executed action.

Referring now to Block 204 of FIG. 2, the method includes determining the last service date for the automated teller machine associated with the executed action. The service date associated with the executed action is used to determine if the information regarding the executed action request has already been collected through a prior service date. If collected, a new service date is unnecessary, and the service schedule can continue unchanged.

Referring now to Block 206 of FIG. 2, the method includes comparing the last service date for the automated teller machine associated with the executed action to the executed action date. The comparison of the last service date to the executed action date is used to determine if issues may arise due to the differences in executed action date and the next scheduled servicing date. If, for instance, an executed action date occurred after the last service date associated with the executed action, then the comparison shows that the information collected at the last service date will be of limited use to resolving the issue occurring with the recently executed action.

To determine whether the information relating to the executed action has been collected from the ATM, the comparison of the last service date for the automated teller machine associated with the executed action to the executed action date includes determining whether the last service date for the ATM was before or after the executed action date. In an instance in which the last service date was before the executed action date, then a service has not been completed since the executed action and therefore, a service of the ATM is needed to obtain the information relating to the executed action. In such an instance, the method may include the operations discussed in reference to Block 208 of FIG. 2. In an instance in which the last service date was after the executed action date, then a service has been completed since the executed action and the information relating to the executed date has been retrieved from the ATM. For example, deposited checks may be retrieved from an ATM and stored in one or more centralized location that can be easily accessed and retrieved for the review discussed herein.

Referring now to Block 208 of FIG. 2, the method includes causing a service action related to the automated teller machine to be executed based on determining the last service date is before the executed action date. In an instance in which the ATM has not be serviced since the executed action date, the system is configured to either determine the next scheduled service or schedule a new service.

The service action may include determining the next scheduled service for the ATM related to the executed action. Based on the next scheduled service date, the service action may include scheduling or re-scheduling a service of the automated teller machine associated with the executed action within a predetermined amount of time. In some instances, the service action may include determining the next service date for the automated teller machine associated with the executed action and comparing the next service date with the predetermined amount of time that a service is requested (e.g., if a service is recommended within 5 days and the next service date is in 3 days, the previously scheduled service may be maintained). For example, a review of a dispute may need to be completed within a certain number of days and therefore, as long as the next scheduled service occurs within the review time period, no new service would need to be scheduled.

In some embodiments, the service action may be caused to be executed in part due to a notification from one of the systems overseeing the operation of the automated teller machine. For example, if the resources in the automated teller machine fall below a predetermined value, then the system that monitors the resource level of the automated teller machine would prompt a request for the automated teller machine to be serviced. This request would be communicated with other systems overseeing the operation of the automated teller machine.

In some embodiments, the service action may be caused to be executed in part due to a category of usage in terms of the executed action that occurs. A category of usage could include a system that weighs the urgency to resolve issues occurring. For example, if the magnitude of the executed action is above a predetermined value (e.g., above a predetermined dollar amount) and an error occurs that assigns the wrong magnitude to the executed action, then the service action may be executed upon determining the last service date is before the executed action date.

In various embodiments, the servicing of automatic teller machines is done on an established schedule. Servicing the automated teller machine outside of the established schedule presents additional logistic, time-based, and resource-based issues. The reduction of servicing dates outside of the established schedule thus presents a more efficient use of resources. Through the communication of several cross-channel systems, the number of service requests placed outside of the established schedule are reduced. The cross-channel communication between systems encourages service dates to be placed within the established schedule or to satisfy said systems with less unscheduled service dates.

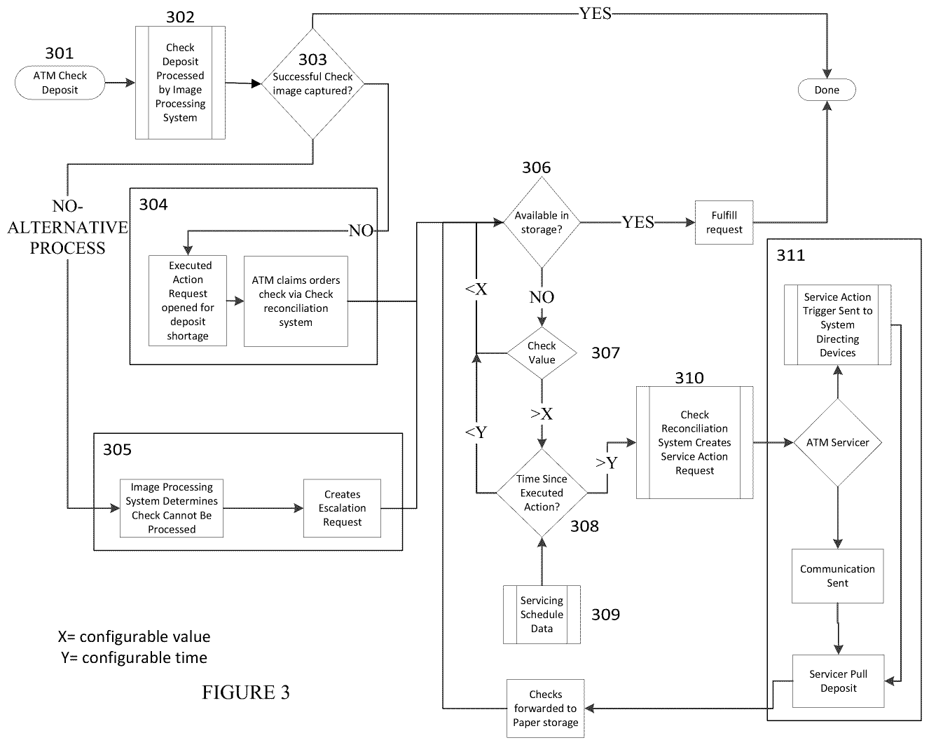

FIG. 3 illustrates an example review process that occurs for a dispute of a check deposited into the automatic teller machine. Various systems and components discussed in reference to FIG. 3 may be carried out by the various components of the distributed computing environment 100 discussed herein (e.g., the systems 130, one or more end-point devices 140, etc.).

As shown in Block 301 of FIG. 3, a check may be deposited into an ATM. As seen in Block 302 in FIG. 3, the image processing system captures the image of the inserted check. The image processing system may include capabilities to scan checks when inserted into the automatic teller machine. If successful, the system would record the value of the inserted check. If unsuccessful, the system could determine that the image was not processed correctly, and corrective action may be taken.

Referring to Block 303 in FIG. 3, as the check is deposited into the automatic teller machine it is processed by the image processing system. If the image of the check was successfully captured, then the process is finished and there is no further reason for escalation. In such an instance, a reviewer can view the image of the check and make a determination for the dispute without needing to view the physical check. If the image was not successfully captured, then the reviewer could not make a determination based on the image of the check and additional steps would be necessary. In the example shown in FIG. 3, there may be two options for review in an instance the image capture was unsuccessful.

If the image was unsuccessfully captured as seen in Block 303 in FIG. 3, then an executed action request could be opened using a check reconciliation system (Block 304). The check reconciliation system is another example of a system participating in cross-channel communication. The check reconciliation system may process the reception of checks into the automatic teller machine. The system may monitor the day and time an executed action was made using the automatic teller machine. The check reconciliation system could also open an executed action request if an issue were to occur in the processing of the check. The system may also be able to open a dispute due to the issues associated with the processing of the check into the automated teller machine.

The check reconciliation system may also be able to determine when a service action may be requested, as seen in Block 305 in FIG. 3. The service action request may occur due to factors such as the magnitude of the check, the ability to store the check in a paper storage, or the number of days since the executed action may have occurred.

The check reconciliation system would then determine if the check deposited is available in storage as seen in Block 306 in FIG. 3. In this example, a check is available in storage in an instance in which the ATM related to the executed action has been serviced and the physical check has been retrieved from the ATM (and stored in a centralized storage). In an instance in which the check is in storage (e.g., has been retrieved from the ATM), then the check may be retrieved from storage for review.

Referring to Block 307 in FIG. 3, the inserted check would then be analyzed to determine whether the magnitude of the dispute exceeds a predetermined configurable dispute magnitude X. If the magnitude is determined to be greater than the predetermined configurable dispute magnitude X, the check will move forward for continued analysis. If the magnitude is determined to be below the predetermined configurable dispute magnitude, the check will return to Block 306 (e.g., repeat until the check is in storage). The predetermined configurable dispute magnitude X may be determined based on a threshold level of security. For example, disputes above a certain value may be more important to resolve quickly than lower value disputes.

Referring to Block 308 in FIG. 3, the time that has passed since the check was inserted into the automatic teller machine would be analyzed. This analysis would also use the information provided by the Servicing Schedule Data in Block 309. If the time that has passed is greater than a predetermined configurable time Y, then the inserted check moves forward into Block 310, at which point a service action request may be triggered. If the time that has passed is less than a predetermined configurable amount of time Y, then the inserted check will move back into Block 306 (e.g., repeat until the time since executed action is greater than the predetermined configurable time Y).

Referring to Block 311 in FIG. 3, the triggered service action request may be sent to multiple sources. These sources may include a device directing system and an outside system tasked with resolving discrepancies in similar scenarios. Once this analysis has been conducted, the check will be forwarded to paper storage and return to Block 306.

A device directing system is another example of a system participating in cross-channel communication that could transmit when emergency servicing of the automated teller machine may be dispatched. The reasons for emergency servicing could be based on a category of usage such as excessive use of the automated teller machine wherein the number of executed actions in a predetermined time frame exceeds a predetermined number.

Another example of a system participating in cross-channel communication would be a resource measurement system that monitors the resource levels available in an automated teller machine. Said system can include analysis of when the resource levels of an automated teller machine are approaching a predetermined value in which corrective actions may be taken. Said system may also monitor the resource levels within the automated teller machine at a given day and time as requested. In a cross-communication environment, the system would communicate when service actions may occur based on the resource levels of the automatic teller machine. While the various systems discussed in reference to FIG. 3 are each referenced as systems, various systems may be combined to carry out multiple operations discussed herein.

In various embodiments, at least one processing device is configured to determine a next service date of the automated teller, wherein the service action comprises a transmission of a request for expedited servicing in an instance in which the next service date is greater than a predetermined number of days from an executed action request date that the executed action request was received. If a system that is engaged in cross-channel communication and determines that a new service date may be scheduled, the new service date will be accounted for by other participating systems. For example, if service is recommended by the Check Reclamation System within 3 days and the next scheduled service date is 5 days, a request will be transmitted to schedule a new service date within the 3-day time frame. The time frame for service may be based on various factors, include amount of dispute, regulations on reviews, and/or the like. The image processing system, resource measurement system, the device directing system, and any other system engaged in the cross-channel communication will be notified of the new service date and will be updated accordingly.

The determination of whether to execute a service action can be based off several categories of usage. The service action may be transmitted in circumstances that would result in efficient use of resources and time. The service action could include the calculation of a new servicing date but declining to send the request as the new servicing date would result in an inefficient use of resources. In another example the service action may be executed in an instance in which the newly calculated servicing date would result in more efficient use of resources and time compared to the scheduled servicing date already in place.

The transmission criteria for a service action are configurable and can be configured to target the request that encourages benefits and discourages potential disadvantages. For example, if the configured settings indicate that the benefits of a servicing action request within a 5-day window are greater than a request within a 3-day window, the system will recommend the 5-day window.

In various embodiments, the service action is a transmission of a request for servicing of the automated teller machine within a predetermined number of days. For example, if an executed action results in the automated teller machine requiring service within 7 days based off a system that monitors the resources within the automated teller machine, and a system that monitors the processing of checks says a new servicing date is recommended within a 9-day window, a new service date will be calculated within the 7-day window. This calculation would be made by the communication of systems involved in the operation of the automated teller machine.

In various embodiments, the service action is a transmission of a request to update a service schedule of the automated teller machine. The request to update the service schedule of the automated teller machine can be communicated with other systems regarding the operation of the automatic teller machine. For example, the transmission of the request can be transmitted to notify the system that manages the processing of checks that an updated servicing date will occur, and the new date can be processed by said system for further action.

In various embodiments, the executed action request is based on a potential malfunction in the processing of the executed action by the automated teller machine. The potential malfunction could include the automatic teller machine performing an undesired action or performing an action with an incorrect value. For example, a check may be deposited into the automatic teller machine and the value recorded is incorrect by an order of magnitude. A further example can include a withdrawal that deducts the correct amount in the system of the automated teller machine but dispenses an incorrect amount in practice. The malfunction can include failure to credit full or partial values involved in the interaction. The malfunction can also include failure to credit full or partial values involved in either a withdrawal-based interaction or a deposit-based interaction. The occurrence of these errors and similar errors that result in an interaction with incorrect values would result in the processing of the executed action request to resolve the malfunction.

In various embodiments, the potential malfunction in the processing of the executed action by the automated teller machine is an imaging error of the automated teller machine. In the situation in which an error occurs, the executed action request would be issued to service the automated telling machine. The service in this scenario would include the collection of any physical documents produced or collected by the automated teller machine. Furthermore records, information recorded by the automated teller machine, or any information produced by the automated teller machine that can be used to resolve the malfunction will be collected. This information includes the time of the executed action, the resource balance of the automated teller machine before and after the executed action, and any physical documentation such as checks, resources, or receipts.

The imaging error of the automated teller machine may include a misreading on a deposited check. This misreading could be due to illegible writing, foreign contaminants on the deposited check (including but not limited to streaks, smears, and blots), or an error that occurs due to a technical issue regarding the operation of the automated teller machine.

In various embodiments, the executed action is a category of usage of the automated teller machine, wherein the category of usage is one of a check deposit or a cash deposit or a cash withdrawal. The category of executed action may include one type of action (e.g., one check deposit, one cash withdrawal, one cash deposit) or a combination of various actions (e.g., a check deposit and cash deposit, check deposit and cash withdrawal).

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for providing an automated pull request using cross-channel communication, the system comprising:
at least one non-transitory storage device; and
at least one processor coupled to the at least one non-transitory storage device, wherein the at least one processor is configured to:
receive an executed action request, wherein the executed action request comprises a request to obtain information relating to an executed action performed on an executed action date, wherein the information relating to the executed action is obtained via servicing an automated teller machine associated with the executed action;
determine a last service date for the automated teller machine associated with the executed action;
compare the last service date for the automated teller machine associated with the executed action to the executed action date; and
based on determining the last service date is before the executed action date, cause a service action related to the automated teller machine to be executed.

2. The system of claim 1, wherein the at least one processing device is configured to determine a next service date of the automated teller machine, wherein the service action comprises a transmission of a request for expedited servicing in an instance in which the next service date is greater than a predetermined number of days from an executed action request date that the executed action request was received.

3. The system of claim 1, wherein the service action is transmission of a request for servicing of the automated teller machine within a predetermined number of days.

4. The system of claim 1, wherein the service action is a transmission of a request to update a service schedule of the automated teller machine.

5. The system of claim 1, wherein the executed action request is based on a potential malfunction in a processing of the executed action by the automated teller machine.

6. The system of claim 5, wherein the potential malfunction in the processing of the executed action by the automated teller machine is a photographic processing error of the automated teller machine.

7. The system of claim 1, wherein the executed action is a category of usage of the automated teller machine, wherein the category of usage is one of a check deposit or a cash deposit.

8. A computer program product for providing an automated pull request using cross-channel communication, the computer program product comprising at least one non-transitory computer-readable medium having computer-readable program code portions embodied therein, the computer-readable program code portions comprising:
an executable portion configured to receive an executed action request, wherein the executed action request comprises a request to obtain information relating to an executed action performed on an executed action date, wherein the information relating to the executed action is obtained via servicing an automated teller machine associated with the executed action;
an executable portion configured to determine a last service date for the automated teller machine associated with the executed action;
an executable portion configured to compare the last service date for the automated teller machine associated with the executed action to the executed action date; and
an executable portion configured to cause a service action related to the automated teller machine to be executed based on determining the last service date is before the executed action date.

9. The computer program product of claim 8, wherein the computer program product further comprises an executable portion configured to determine a next service date of the automated teller machine, wherein the service action comprises a transmission of a request for expedited servicing in an instance in which the next service date is greater than a predetermined number of days from an executed action request date that the executed action request was received.

10. The computer program product of claim 8, wherein the service action is transmission of a request for servicing of the automated teller machine within a predetermined number of days.

11. The computer program product of claim 8, wherein the service action is a transmission of a request to update a service schedule of the automated teller machine.

12. The computer program product of claim 8, wherein the executed action request is based on a potential malfunction in a processing of the executed action by the automated teller machine.

13. The computer program product of claim 12, wherein the potential malfunction in the processing of the executed action by the automated teller machine is a photographic processing error of the automated teller machine.

14. The computer program product of claim 8, wherein the executed action is a category of usage of the automated teller machine, wherein the category of usage is one of a check deposit or a cash deposit.

15. A computer-implemented method for providing an automated pull request using cross-channel communication, the method comprising:
receiving an executed action request, wherein the executed action request comprises a request to obtain information relating to an executed action performed on an executed action date, wherein the information relating to the executed action is obtained via servicing an automated teller machine associated with the executed action;
determining a last service date for the automated teller machine associated with the executed action;
comparing the last service date for the automated teller machine associated with the executed action to the executed action date; and
causing a service action related to the automated teller machine to be executed based on determining the last service date is before the executed action date.

16. The method of claim 15, further comprising determining a next service date of the automated teller machine, wherein the service action comprises a transmission of a request for expedited servicing in an instance in which the next service date is greater than a predetermined number of days from an executed action request date that the executed action request was received.

17. The method of claim 15, wherein the service action is transmission of a request for servicing of the automated teller machine within a predetermined number of days.

18. The method of claim 15, wherein the service action is a transmission of a request to update a service schedule of the automated teller machine.

19. The method of claim 15, wherein the executed action request is based on a potential malfunction in a processing of the executed action by the automated teller machine.

20. The method of claim 15, wherein the executed action is a category of usage of the automated teller machine, wherein the category of usage is one of a check deposit or a cash deposit.
